(19) United States
(12) Patent Application Publication
(10) Pub. No.: US 2002/0098268 A1
(43) Pub. Date: Jul. 25, 2002

(54) Container for mixing

(76) Inventors: Eric D. Cohen, Wellesely, MA (US); Kevin M. Johnson, Natick, MA (US); Adrian M. West, West Newton, MA (US)

Correspondence Address: HAYES, SOLOWAY, HENNESSEY, GROSSMAN & HAGE, PC, 175 Canal Street, Manchester, NH, 03101, US

(21) Appl. No.: 09/989,589

(22) Filed: Nov. 20, 2001

Related U.S. Application Data
(60) Provisional application No. 60/249,964, filed on Nov. 20, 2000.

(51) Int. Cl. A23B 4/00

(52) U.S. Cl. 426/112

(57) ABSTRACT

An apparatus and method for containing and mixing a food product for direct distribution to a consumer. The container includes an agitator for mixing the food product, optionally with an added liquid such as water, milk or juice. The agitator may be incorporated into the base of the container. The agitator remains coupled to the container, which container can be made disposable/recyclable, which therefore provides an expedient method for food delivery.

### CROSS REFERENCE TO RELATED APPLICATIONS

This application claims the benefit of copending U.S. provisional application serial No. 60,249,964 filed Nov. 20, 2000, the teachings of which are incorporated herein by reference.

### FIELD OF THE INVENTION

The present invention relates to a packaging system that delivers pre-measured doses of separate foods so that said food can be more conveniently and easily used in published and/or custom blending or mixing recipes. The invention herein therefore creates the situation wherein a user can prepare food with freshly blended or mixed taste, nutrient, and texture without the effort of measuring and preparing each ingredient.

### BACKGROUND OF THE INVENTION

Culinary professionals and nutritionists are praising the superior taste and nutritional content of whole foods. At the same time, people have less and less time to shop for and prepare whole foods that they can incorporate into their diets. The strength of these two trends is indicated by the continued success of establishments purveying freshly blended fruit and vegetable drinks or freshly baked foods. Some people who strive to prepare freshly blended and mixed foods at home get the opportunity so infrequently that the fresh foods they are able to purchase and bring home have spoiled by the time they are ready to use them. Another barrier to making blended and mixed foods for time crunched or inexperienced consumers is the time and effort required to plan, measure and prepare the ingredients. Finally, after an individual has gone through the effort of making a blended or mixed food, the time and drudgery associated with cleaning up measuring spoons and cups, cutting boards, and bowls is likely to give them a reason to avoid this pursuit in the immediate future.

### SUMMARY OF THE INVENTION

In broad embodiment, the present invention comprises a packaging system for keeping fresh and delivering prepared, minimally processed, pre-measured doses of food. The food can include but is not limited to dairy products such as yogurt, milk, cream, ice cream, fruits such as oranges, apples, bananas, grapes, vegetables such as carrots, celery, beets, flavorings such as sugar, honey, and spices. The food can be whole or processed. Processing can include, but is not limited to cutting, peeling, pickling, sugaring, stewing, mixing, toasting, baking, frying, and preserving. The food can be kept fresh by sealing and/or refrigerating or freezing it. Foods that are packaged together but must not be mixed until immediately before being consumed can be separated using a plastic barrier or an edible barrier. The barrier can be water soluble such as a starch or sugar film.

It can be appreciated herein that in one embodiment, the present invention provides a system for ingredient delivery that allows the user to incorporate minimally processed foods into mixed and blended recipes, such as fruit smoothies, milkshakes, baked goods, etc.—without measuring and without preparing them. Various modifications of the present invention are of course possible, and are therefore included in the broad scope of the disclosure herein.

Therefore, it is an object of the invention herein to provide a system for ingredient delivery that allows the user to incorporate minimally processed foods into mixed and blended recipes, such as fruit smoothies, milkshakes, baked goods, etc.—without measuring and without preparing them.

It is also an object of the invention to deliver all the ingredients required for a recipe in a single container or in a consistent and co-located form at the point of sale so as to eliminate the hassle of procuring ingredients.

It is also an object of this invention to keep foods separate until they are ready to be blended or mixed and consumed so as afford an individual, as closely as possible, the same taste, texture and nutrients that would be provided by fresh whole foods.

It is also an object of this invention that the food package includes the container and mixing element required to mix the ingredients so that no other containers are used or must be cleaned. This included container and mixing element could be disposable or collectible.

It is also an object of the invention to provide a prepackaged food product comprising a container having a connector at an open end for securing the container to a mixing apparatus, an airtight seal covering the open end, a food product enclosed between the container and the seal, and a cover securable to the open end, the cover comprising an agitator for causing mixing of the food product.

It is also an object of the invention to provide a prepackaged food product comprising a container, a divider for dividing the container into a plurality of smaller compartments, the divider contained within an interior volume of the container wherein a first compartment comprises a first food product and a second compartment comprises a second food product, and so on.

It is also an object of the invention to provide a prepackaged food product comprising a container having an interior volume and an open end, a food product, an agitator spaced from the open end for causing mixing of the food product, and an airtight seal covering the open end.

It is also an object of the invention to provide a drive mechanism, comprising a housing, the housing configured to engageably couple a pair of parallel generally planar surfaces, and a motor substantially enclosed within the housing, the motor having an output shaft, the motor coupleable to a power source for causing actuation of the output shaft to drive the agitator within the food container.

It is also an object of the invention to provide a prepackaged food product comprising a container having a first end and a second end, the container comprising a connector at the first end for securing the container to a mixing apparatus, a first airtight seal covering the first end, a second airtight seal covering the second end, and a food product disposed within the container.

It is also an object of the invention to provide a container for holding a liquid, comprising a base portion, the base portion having a first generally planar region proximate a perimeter, an upwardly standing region located within the base portion, an agitator integral with the upwardly standing region, and a side wall extending upwardly from the base portion about the perimeter.

It is also an object of the invention to provide a prepackaged food product, comprising a base portion, an agitator mechanically coupled to the base portion, a side wall extending upwardly from the base portion, the base portion and the sidewall forming an interior volume, a food product disposed in the interior volume, and an air tight seal contacting the sidewall for preserving the food product.

It is also an object of the invention to provide a blender base comprising a housing, a motor substantially enclosed within the housing, the motor having a longitudinally rotatable output shaft, a linkage coupled to the output shaft and a coupled member, the linkage configured to cause an end of the coupled member to move about a non circular path, and a power source for causing rotation of the output shaft.

It is also an object of the invention to provide a blender base comprising a housing, a motor substantially enclosed within the housing, the motor having an output shaft, a linkage coupled to the output shaft configured to cause a coupled member to oscillate, and a power source for causing rotation of the output shaft.

The above and other objects, feature, and advantages of the present invention will be apparent in the following detailed description thereof when read in conjunction with the appended drawings wherein the same reference numerals denote the same or similar parts throughout the several views.

### BRIEF DESCRIPTION OF THE DRAWINGS

FIG. 1 is a perspective view of a first exemplary prepackaged food product consistent with the present invention;

FIG. 2A is a perspective view of a second exemplar prepackaged food product consistent with the present invention;

FIGS. 2B and 2C are perspective views of a third exemplary prepackaged food product consistent with the present invention;

FIG. 3A is a perspective view of a forth exemplary prepackaged food product consistent with the present invention;

FIG. 3B is a perspective view of a fifth exemplary prepackaged food product consistent with the present invention;

FIG. 4 is a perspective view of a first drive mechanism consistent with the present invention;

FIG. 5 is a perspective view of a container and a second drive mechanism consistent with the present invention;

FIG. 6 is a section view of the container of FIG. 5;

FIGS. 6A, 6B, and 6C are cross section views of a seal having an area of mechanical weakness consistent with the present invention;

FIG. 7 is a perspective view of a sixth exemplary prepackaged food product consistent with the present invention;

FIG. 8A is a perspective view of a seventh exemplary prepackaged food product consistent with the present invention;

FIG. 8B is a perspective view of a eighth exemplary prepackaged food product consistent with the present invention;

FIG. 8C is a perspective view of a ninth exemplary prepackaged food product consistent with the present invention;

FIG. 9A is a perspective view of a first exemplary mechanism for separating a prepackaged food product from its packaging consistent with the present invention;

FIG. 9B is a perspective view of a second exemplary mechanism for separating a prepackaged food product from its packaging consistent with the present invention;

FIG. 9C is a perspective view of a third exemplary mechanism for separating a prepackaged food product from its packaging consistent with the present invention;

FIG. 10 is a perspective view of a tenth exemplary prepackaged food product consistent with the present invention;

FIG. 11A is a perspective view of a first exemplary container consistent with the present invention;

FIG. 11B is a perspective view of a second exemplary container consistent with the present invention;

FIG. 11C is a perspective view of a third exemplary container consistent with the present invention;

FIG. 12 is a front view of a container of FIGS. 11A, 11B, or 11C coupled to a drive mechanism;

FIG. 13 is a partial section view of a third drive mechanism consistent with the present invention;

FIG. 13A is a plan view of a first exemplary linkage useful in the drive mechanism of FIG. 13;

FIG. 13B is a view of the possible paths of an output coupling of the drive mechanism of FIG. 12;

FIG. 14 is a section view of the container of FIG. 11A;

FIG. 15 is a section view of the container of FIG. 11B;

FIG. 15A is an enlarged view of a section of FIG. 15;

FIG. 16 is a section view of the container of FIG. 11C, and

FIG. 17 is a cut away view of another exemplary container consistent with the present invention.

### DETAILED DESCRIPTION OF THE INVENTION

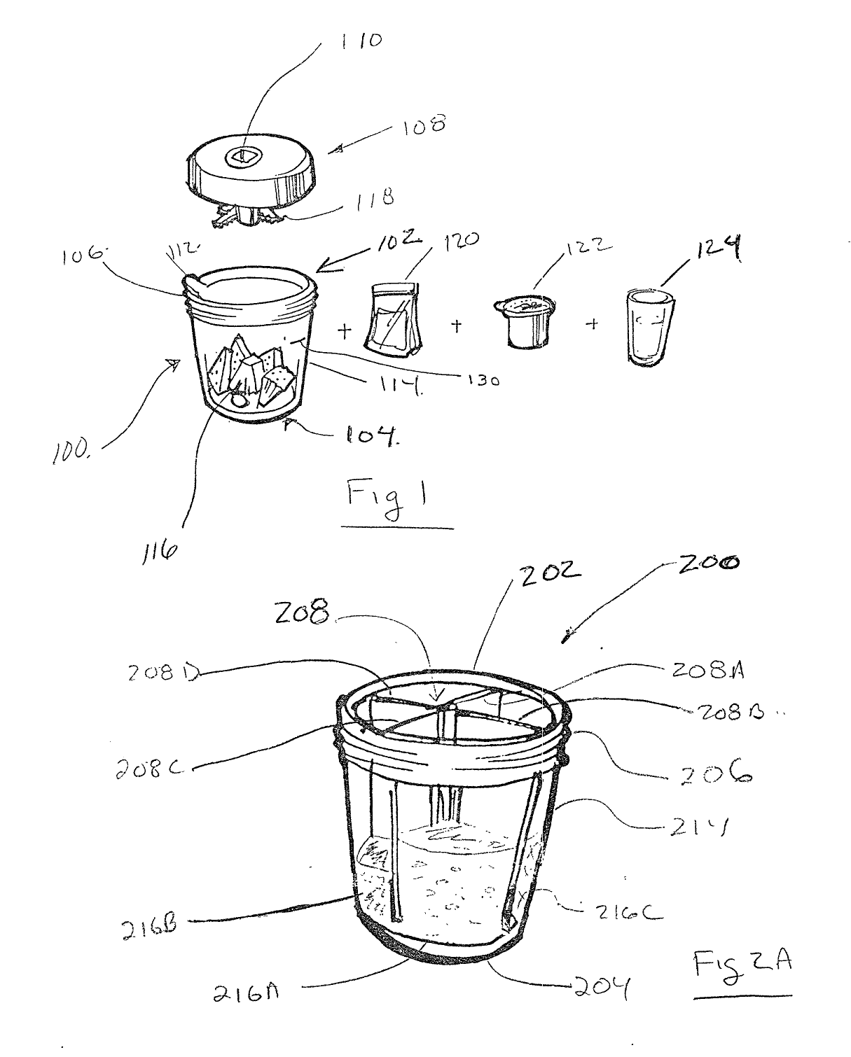

FIG. 1 shows a prepackaged food product 100 including a container 114. The container 114 has a base portion 104 and an open end 102. A connector 106 is disposed about the open end 102 for securing the container 114 to a mixing apparatus. In one embodiment, the connector 106 may include a screw thread. In a second embodiment, the connector 106 may include any means for securing the container to the mixing apparatus including but not limited to a press fit connection, a lip, and a latch mechanism. A removable seal 112 may be secured to the open end 102 to maintain an airtight seal. The seal may be made from a foil, plastic, or another suitable material. A food product 116 may be enclosed within an interior volume formed by the container 114 and the open end 102. The interior volume may be 6 oz to 32 oz, preferably 10 oz to 24 oz, more preferably 10 oz to 20 oz. The food product 116 may include but is not limited to dairy products such as yogurt, milk, cream, ice cream, fruits such as oranges, apples, bananas, grapes, vegetables such as carrots, celery, beets, flavorings such as sugar, honey, and spices. The food can be whole or processed. Processing can include, but is not limited to cutting, peeling, pickling, sugaring, stewing, mixing, toasting, baking, frying, and preserving. The prepackaged food product 100 may further include a cover 108 securable to the connector 106 at the open end 102 of the container 114. The cover 108 may include an agitator 118. The agitator 118 may include a single blade or a plurality of blades including metal, plastic or other suitable material. The agitator 118 may be coupled to a drive coupling 110 for causing mixing of the food product 116. The container 114 may include indicia 130 indicative of a predetermined quantity of an ingredient or liquid 124 to be added to the container, for example water, juice, coffee, syrup, or a dairy product, more particularly milk. The indicia 130 may include text or symbols. Other prepackaged foods for example a filler 120 and nuts or chips 122 may be added to the container. These liquids and other food products may be added to the container after the seal 112 has been removed.

After the food product and liquids have been added to the container 114, the cover 108 may be secured to the connector 106 at the open end 102 of the container 114. The drive coupling 110 of the cover 108 may then be coupled to an output shaft of a drive mechanism (not shown).

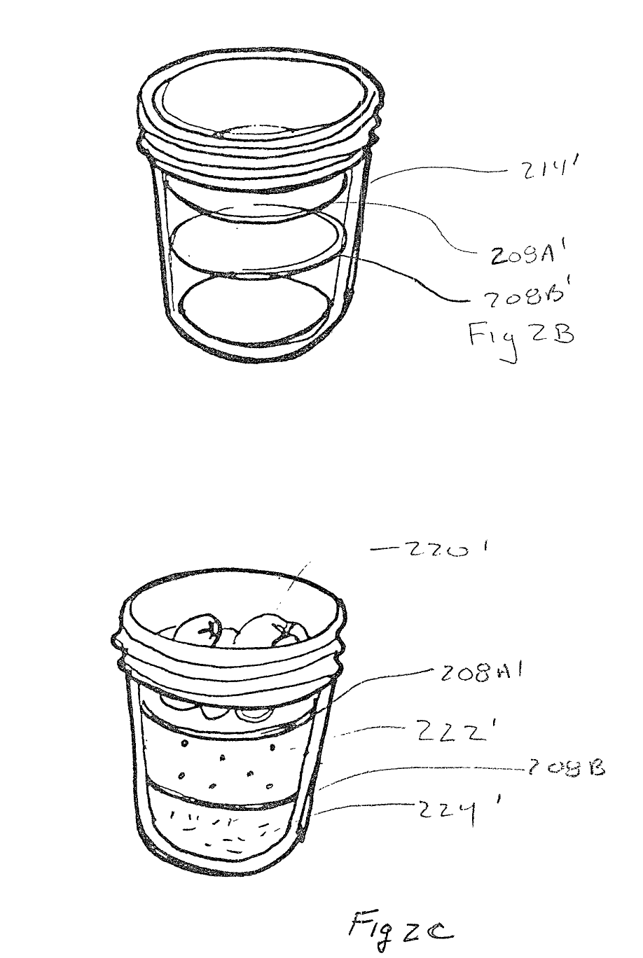

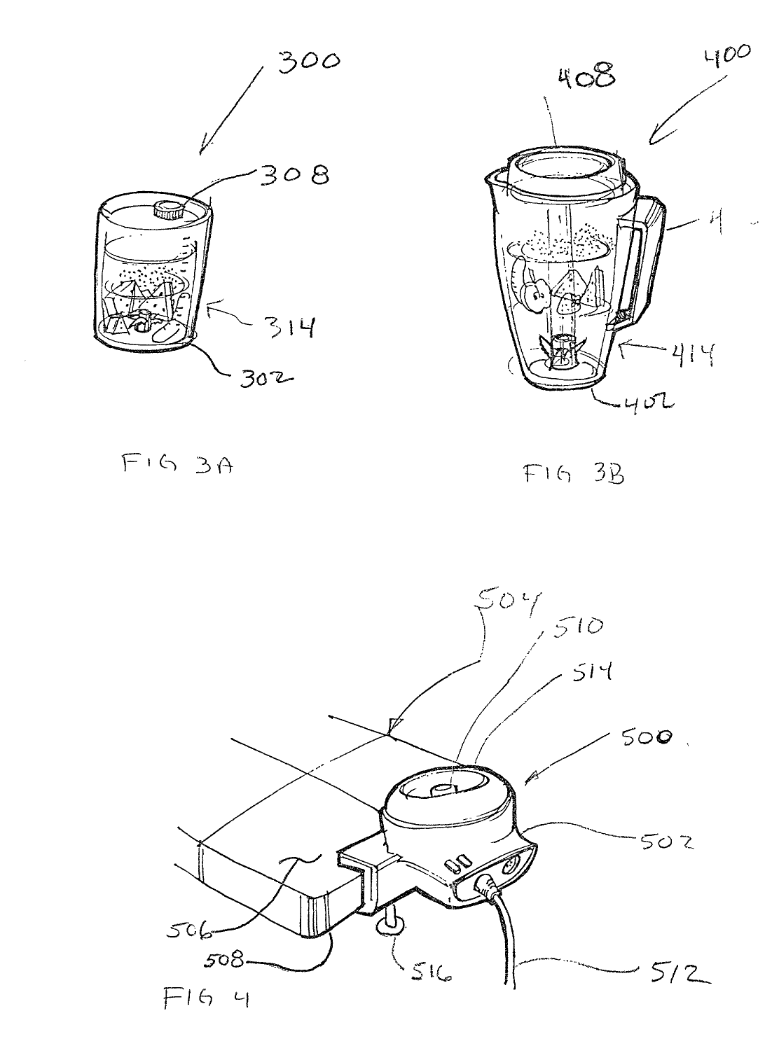

FIG. 2A shows a prepackaged food product 200 including a container 214. The container 214 has a base portion 204 and an open end 202. A connector 206 is disposed about the open end 202 for securing the container 214 to a mixing apparatus. In one embodiment, the connector 206 may include a screw thread. In a second embodiment, the connector 206 may include any means for securing the container to the mixing apparatus including but not limited to a press fit connection, a lip, and a latch mechanism. A removable seal (not shown for clarity) may be secured to the open end 202 to maintain an airtight seal. A first food product 216A, a second food product 216B, and a third food product 216C may be enclosed within an interior volume formed by the container 114 and the removable seal. The interior volume may be 6 oz to 32 oz, preferably 10 oz to 24 oz, more preferably 16 oz to 24 oz. A divider 208 may separate the first food product 216A, the second food product 216B, and the third food product 216C. The divider 208 may be enclosed within an interior volume formed by the container 114 and the open end 202. The divider may include a plastic or a liquid soluble material for example made of a starch or a sugar-based ingredient. The liquid soluble material may be water soluble. The divider 208 may include a plurality of fins 208A, 208B, 208C, and 208D for dividing the interior volume into a plurality of smaller compartments. Each smaller compartment may include a different food product or ingredient. The divider 208 may divide the container into a plurality of generally vertical or generally horizontal compartments. The divider may provide an airtight seal between the different ingredients. The divider 208 may be manually removed to allow the ingredients to come into contact with each other prior to mixing. The container 214 may be coupled to the cover 108 shown in FIG. 1 for mixing of the food products.

FIG. 2B shows a container 214′ including a plurality of generally horizontal dividers 208A′ and 208B′. FIG. 2C show the container 214′ of FIG. 2B with a plurality of food products 220′, 222′, and 224′ separated by a generally horizontal divider 208A′ and 208B′.

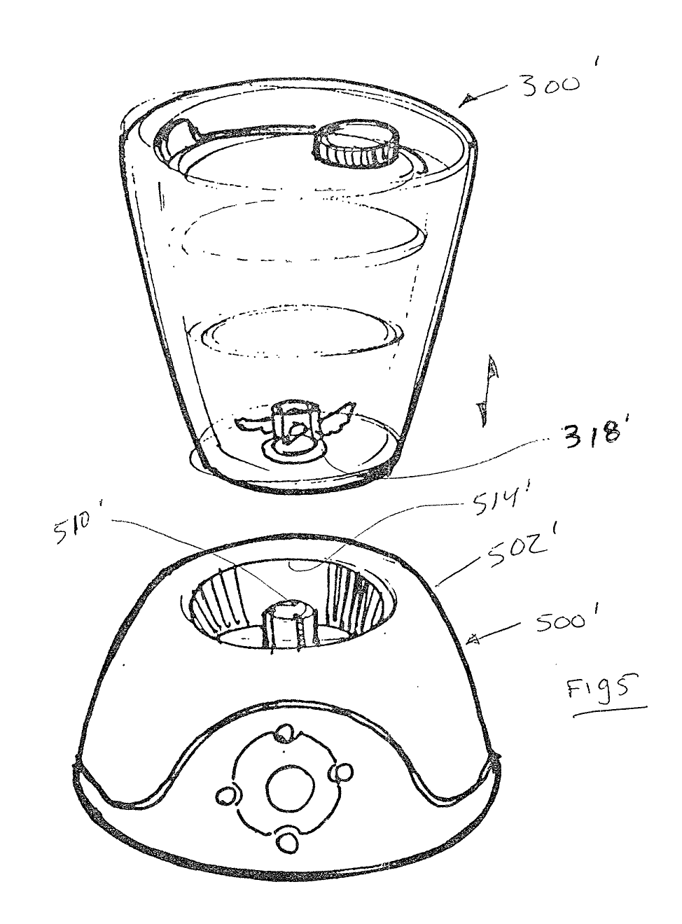

FIGS. 3A shows a prepackaged food product 300. The prepackaged food product 300 may include a container 314 having a base 302 and an opening spaced from the base. The opening may have an airtight seal covering the opening. A removable cap 308 may be disposed over the airtight seal. The cap 308 can be removed and returned more than one time. The airtight seal may allow the pressure within the interior volume to be different from the pressure outside the interior volume. The interior volume may be 6 oz to 32 oz, preferably 10 oz to 24 oz, more preferably 16 oz to 24 oz. For example, the pressure inside the interior of the container may be less than the pressure outside the interior. Air inside the interior of the container may be evacuated prior to placement of the airtight seal. The container defining an interior volume for holding a food product. The airtight seal helping prevent contaminants from contacting the food product. The base 302 may include an agitator spaced from the open end for causing mixing of the food product. The agitator may be coupled to a drive mechanism for causing movement of the agitator. The agitator may rotate or oscillate.

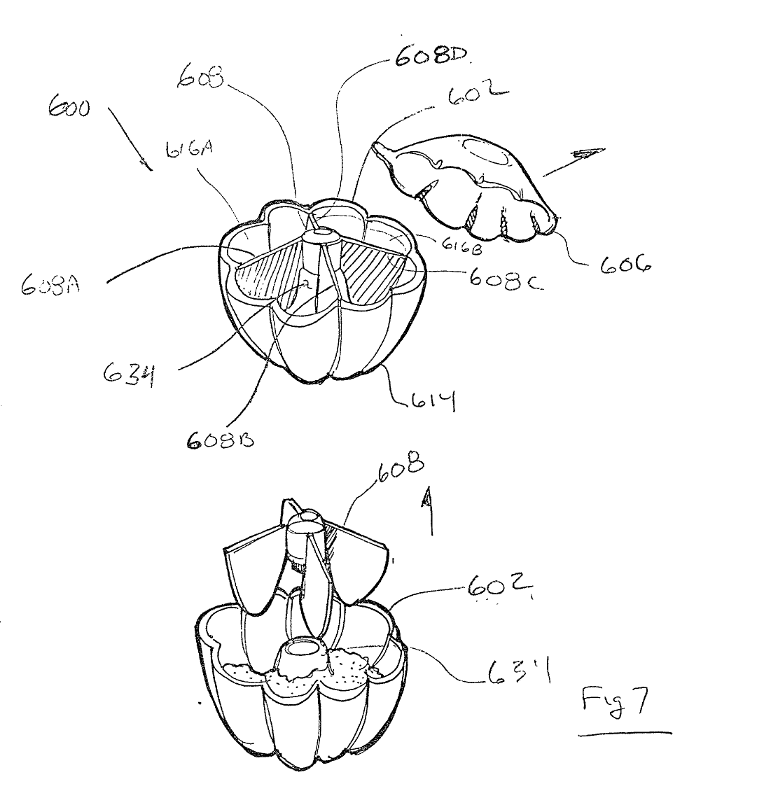

The airtight seal may include an area of mechanical weakness. The area of mechanical weakness may be an area where the seal material has a lower tear strength than the surrounding area (see FIG. 6A), an area where the thickness of the seal is less than that of a surrounding area (see FIG. 6B), or an area including a preformed fracture (see FIG. 6C). The area of mechanical weakness may allow a straw or other utensil to be more easily inserted through the seal

The food product may include but is not limited to dairy products such as yogurt, milk, cream, ice cream, fruits such as oranges, apples, bananas, grapes, vegetables such as carrots, celery, beets, flavorings such as sugar, honey, and spices. The food can be whole or processed. Processing can include, but is not limited to cutting, peeling, pickling, sugaring, stewing, mixing, toasting, baking, frying, and preserving.

FIG. 3B shows a prepackaged food product 400. The prepackaged food product 400 may include a container 414 having a base 402 and an open end spaced from the base 402. The open end may have an airtight seal covering the open end. The container 314 may comprise a handle 410. The interior volume of the container 414 may be 6 oz to 32 oz, preferably 10 oz to 24 oz, more preferably 16 oz to 24 oz.

FIG. 4 shows a drive mechanism 500. The drive mechanism 500 may include a housing 502. The housing may be configured to be coupled to a work surface 504. The work surface 504 including a first generally planar upper surface 506 and a second generally planar lower surfaces 508. The first planar surface 506 generally parallel with the second planar surface 508. The housing may include an adjustable screw 516 to allow the housing to be secured to work surfaces of varying thickness The housing 502 may house a motor (not shown), the motor having an output shaft driven by the motor. The motor is powered by a power source; the power source may be an AC source or a DC source. The motor may be coupled to the source through a line cord 512. The drive mechanism 500 may further include a coupling 510 coupled to the output shaft. The coupling 510 may be driven directly from the output shaft or through a linkage coupled to the output shaft. The directly driven coupling rotating about a longitudinal axis of the output shaft. The linkage driven coupling as shown in FIG. 13A urging the coupling 510 to oscillate. The coupling 510 may be configured to drive an agitator disposed in a base of a mixing container. The housing 502 may include a receiving portion 514 for receiving a portion of a mixing container. The housing 502 may further include an actuator electrically coupled to the motor. The motor configured to operate when the actuator is actuated. The actuator may be disposed within the receiving portion 514 of the housing such that contact with the mixing container causes the motor to operate.

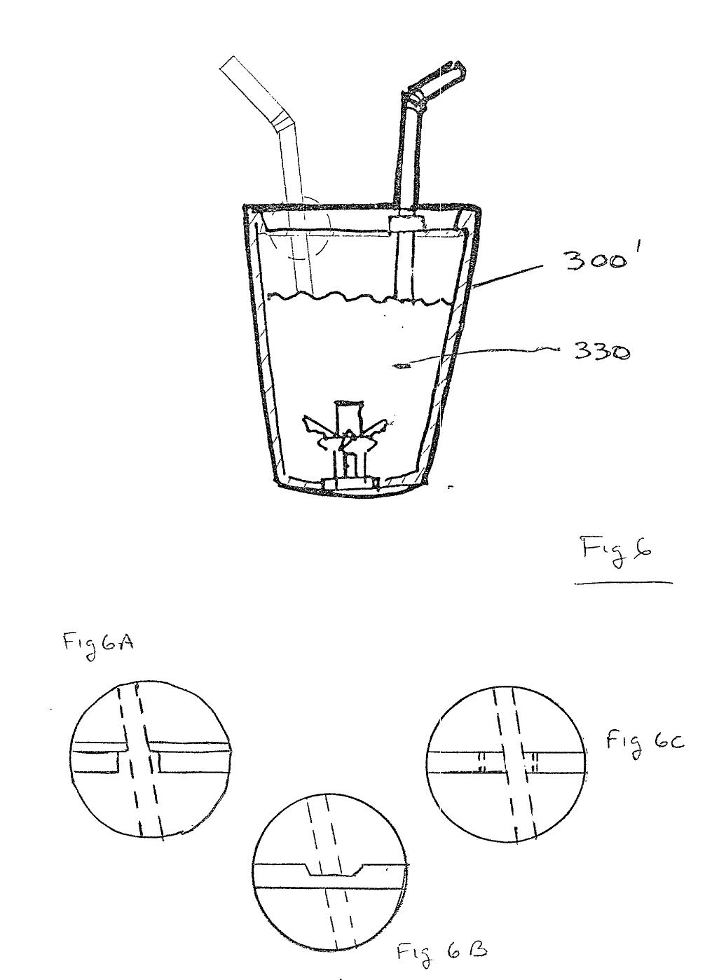

FIG. 5 shows a container 300′ coupleable to a drive mechanism 500′. The drive mechanism 500′ may include a motor having a coupling 510′. The motor may be substantially housed in a housing 502′. The top surface of the housing 502′ may include a receiving portion 514′ preferably shaped to accept a cooperating container 300′.

FIG. 6 shows a cross section view of a container 300′. An indicia 330 may be included on a surface of the container 300′. The indicia may indicate a predetermined quantity of an ingredient or volume of a liquid to be added to the container. The indicia may include text or symbol.

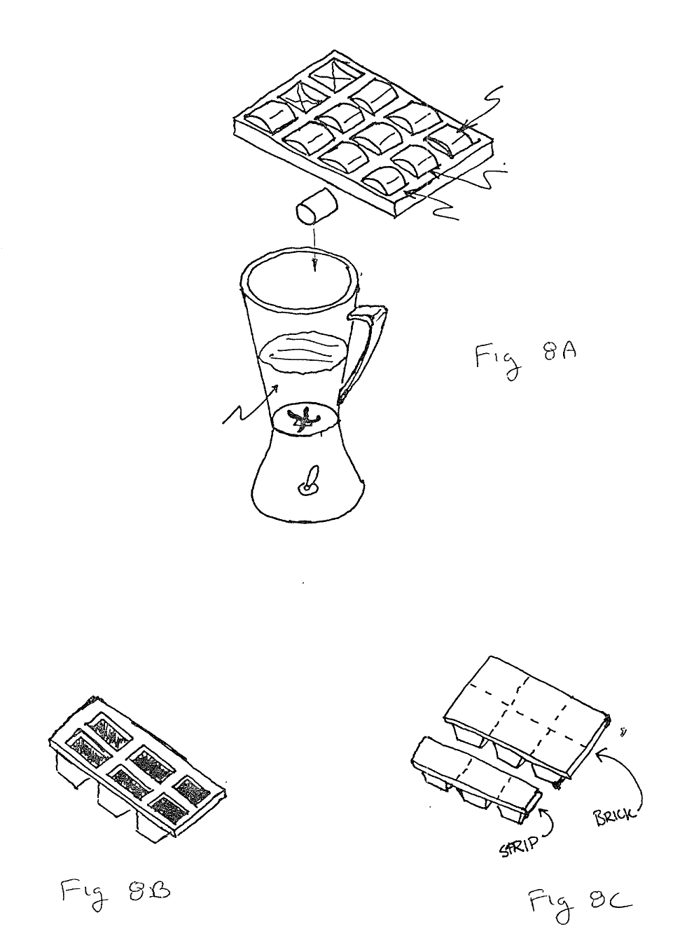

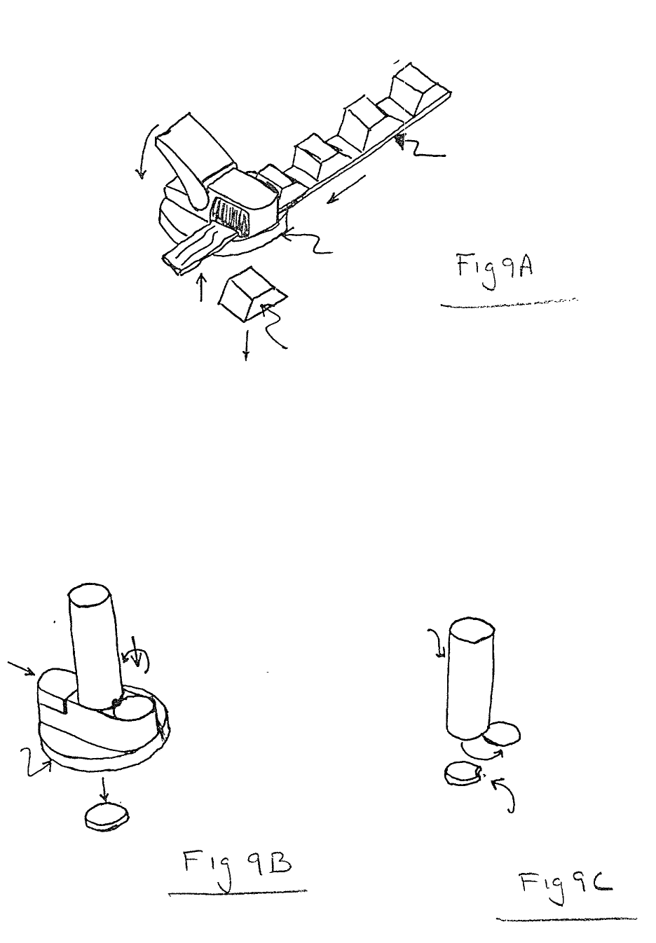

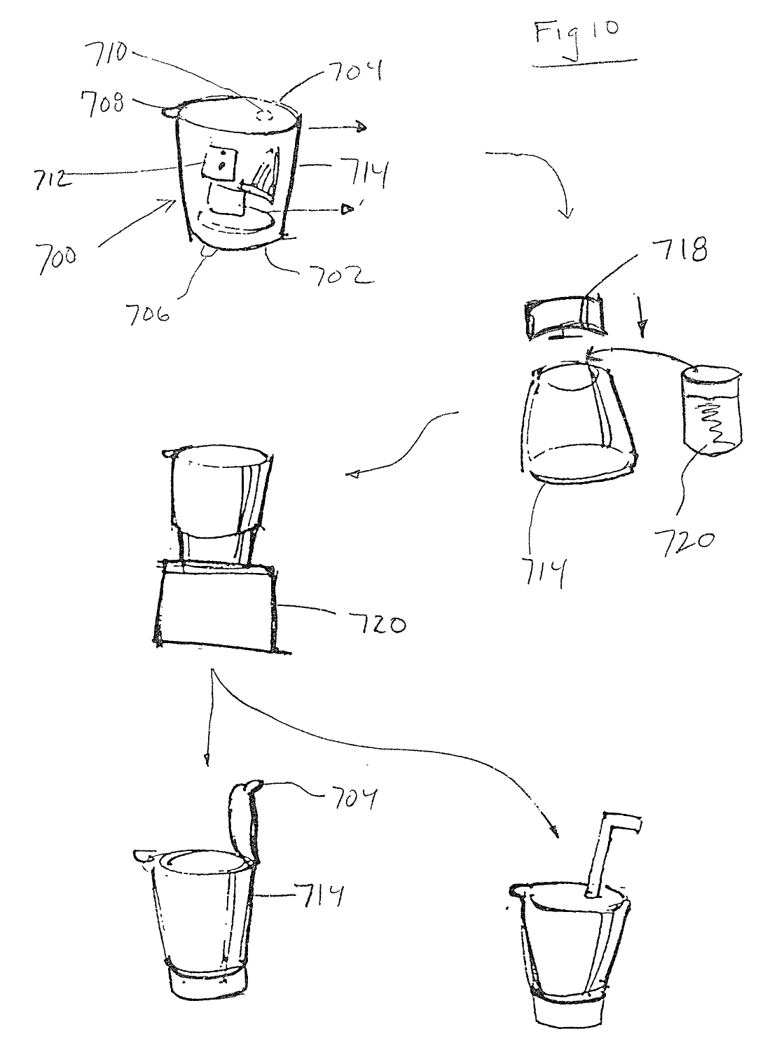

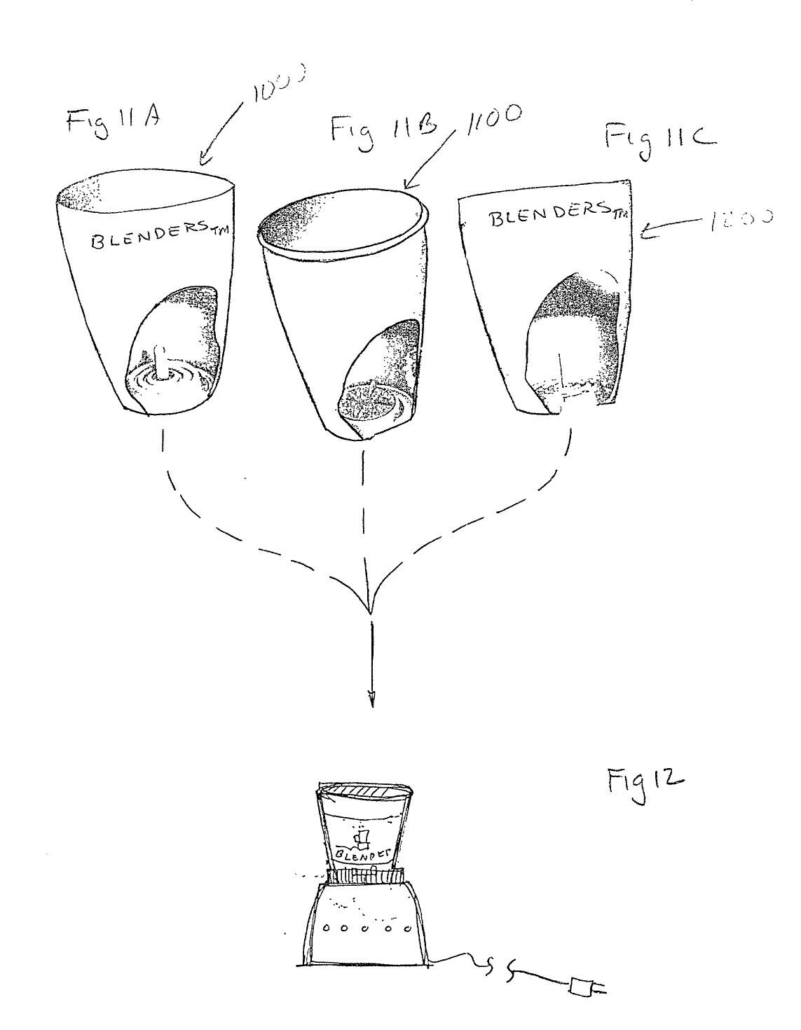

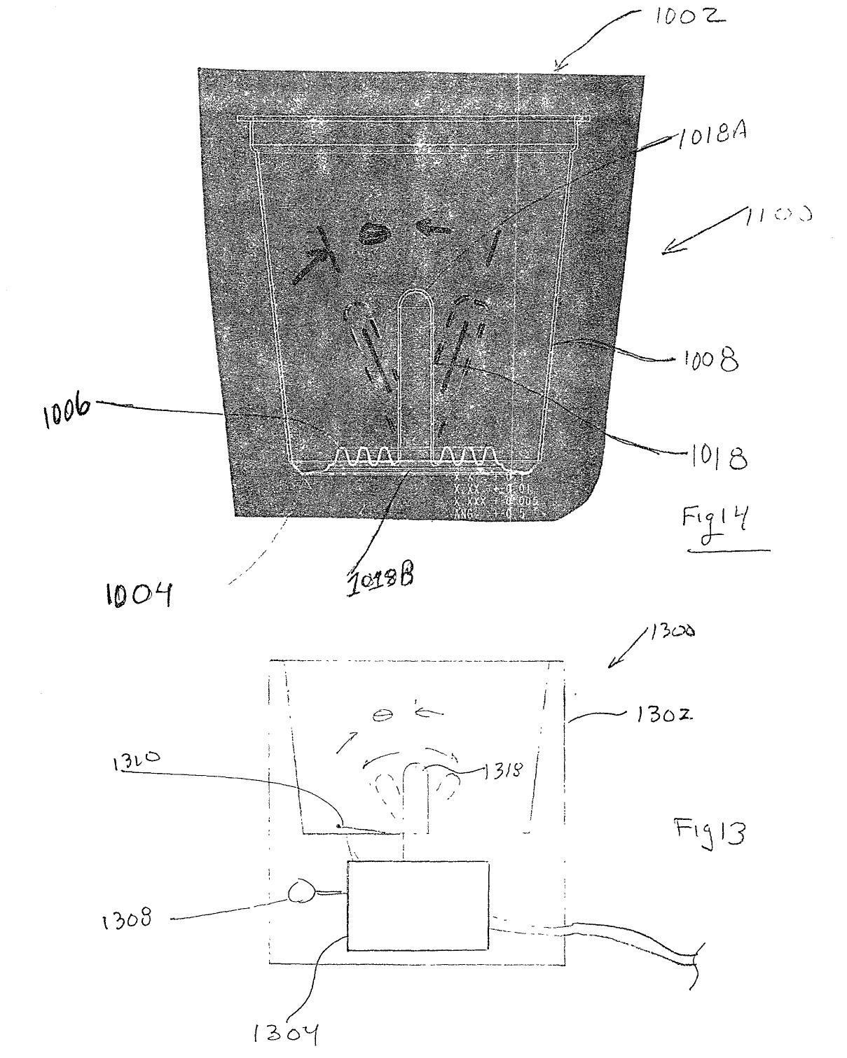

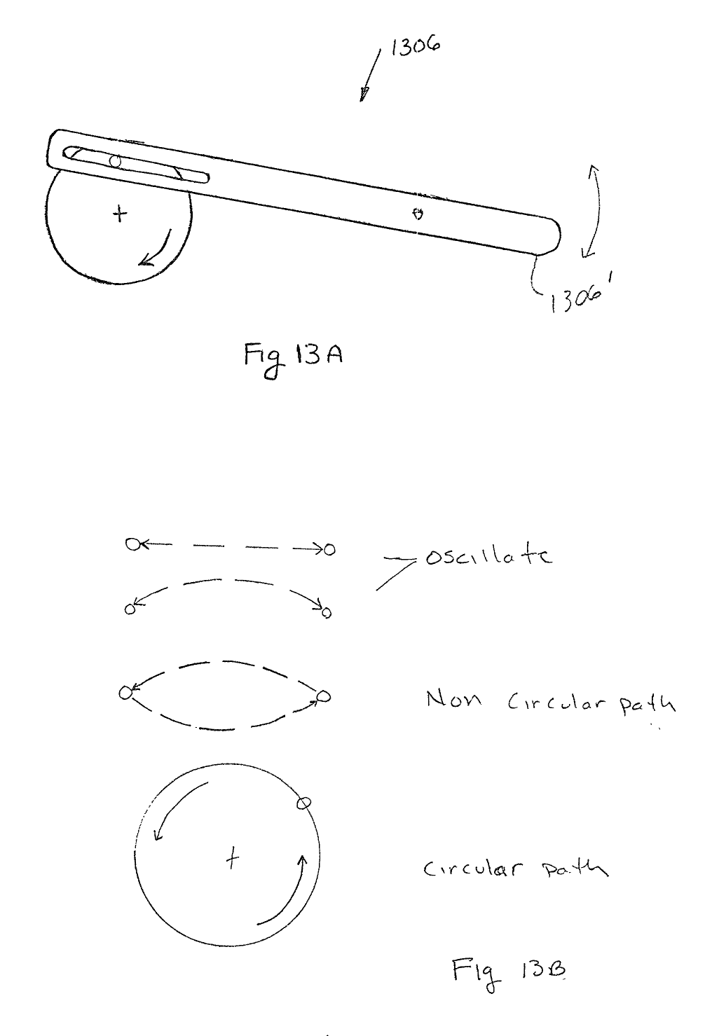

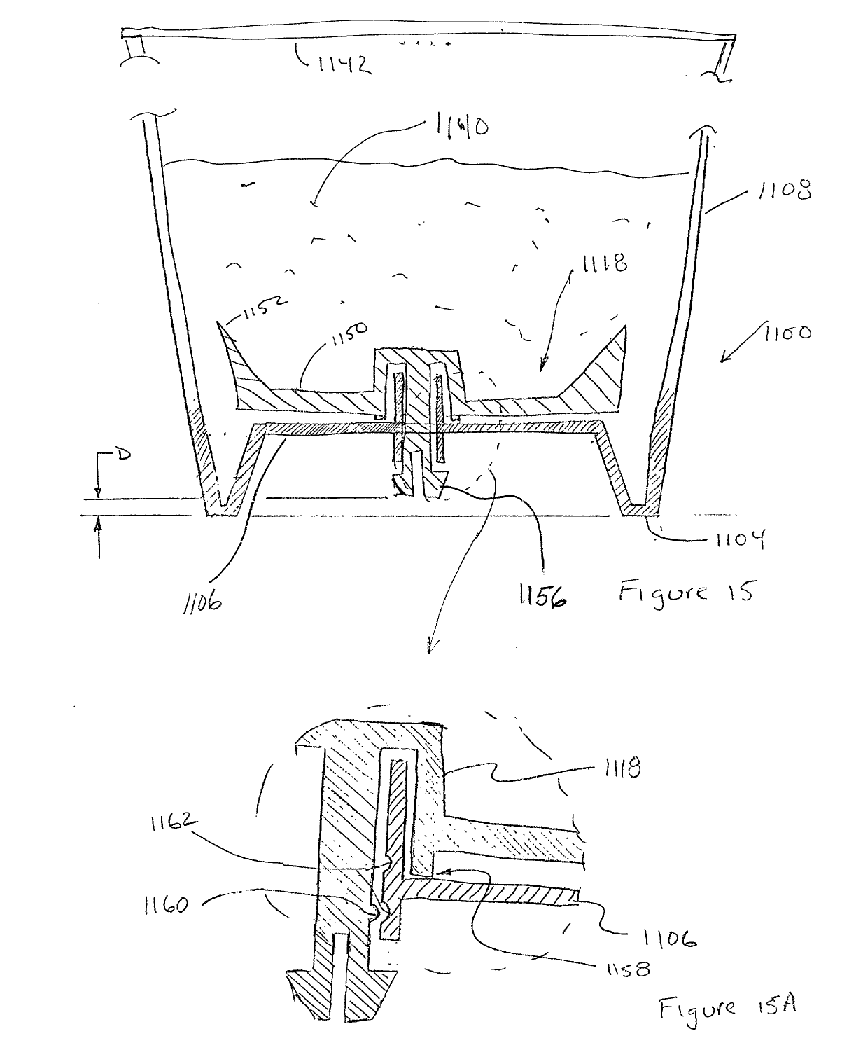

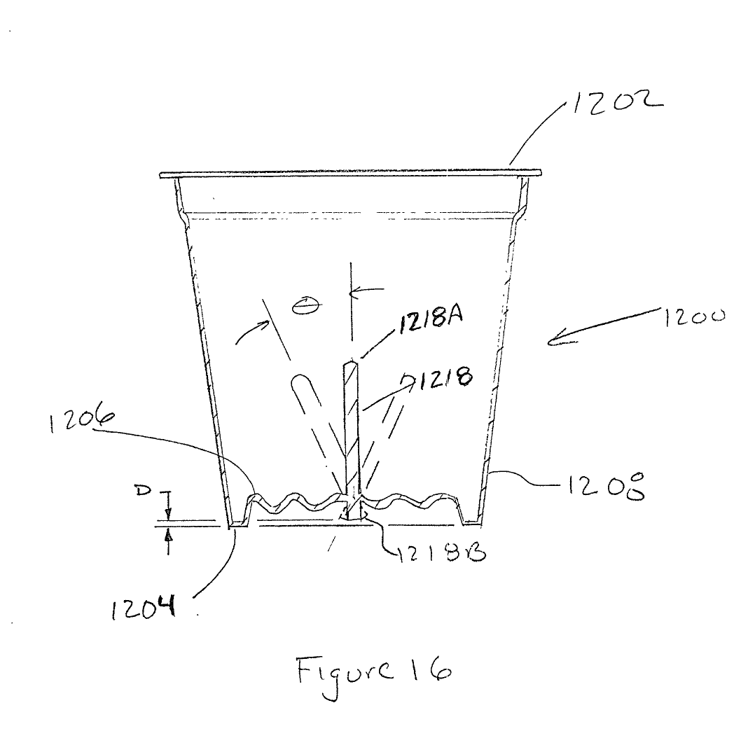

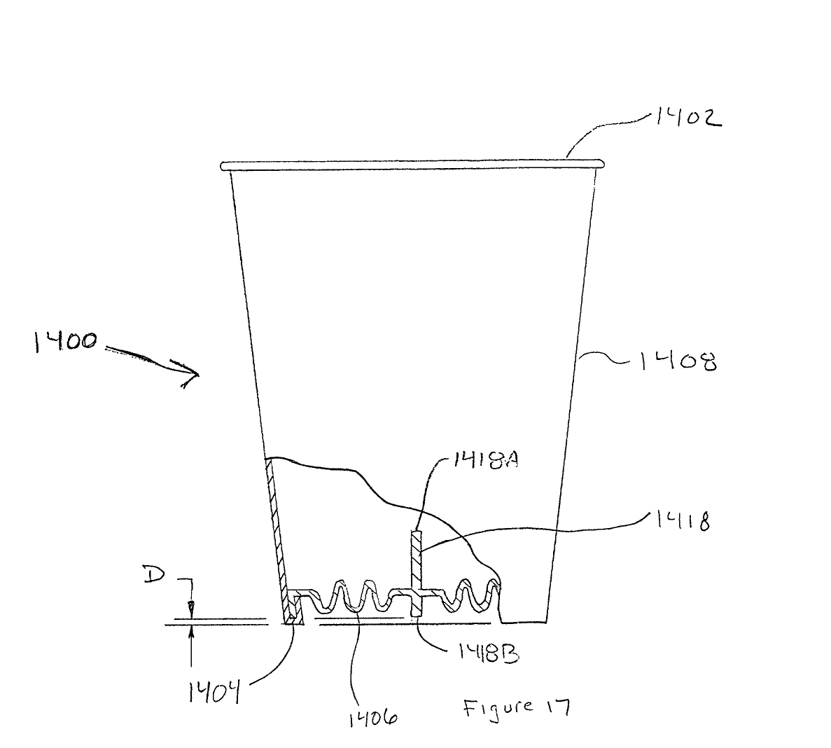

FIG. 7 shows a prepackaged food product 600 including a container 614. The container may be used to cook the ingredients. The container may be made of high temperature plastics, aluminum or other metals. A first food product 616A and a second food product 616B may be enclosed within an interior volume formed by the container 614 and an open end 602. A removable seal 606 may be secured to the open end 602 to maintain an airtight seal. A divider 608 may separate the first food product 616A and the second food product 616B. The divider 608 may be enclosed within the interior volume formed by the container 614 and the open end 602. The divider 608 may include a plastic or a liquid soluble material. The liquid soluble material may be water-soluble. The divider 608 may include a plurality of fins 608A, 608B, 608C, and 608D for dividing the interior volume into a plurality of smaller compartments for each of the food products 616A and 616B. The divider 608 may divide the container 614 into a plurality of generally vertical compartments. The divider 608 may provide an airtight seal between the different food products. The divider 608 may be manually removed to allow the ingredients to come into contact with each other. The container may include a centrally disposed protrusion 634 extending upwardly from the base of the container. The divider 608 may rest on the protrusion and the fins may extend radially outward towards the inside wall of the container. The divider may be coupled to an apparatus that rotates the divider about its center thus mixing the ingredients contained within the container.

FIG. 10 shows a prepackaged food product 700. The prepackaged food product 700 may include a container 714. The container may have a first end 702 and a second end 704. End 702 may have a first removable airtight seal 706 and end 704 may have a second removable airtight seal 708. End 702 may include a connector, for example a screw thread. The airtight seal 708 may include an area of mechanical weakness 710. Contained in an interior volume formed by the container and the first and second seal may be a food product 712. The interior volume may be 6 oz to 32 oz, preferably 10 oz to 24 oz, more preferably 16 oz to 24 oz. The airtight seals help preserve the food product. To begin the mixing process, an individual removes the first airtight seal 706, adds a liquid 720, for example water, milk or a juice, and then secures an agitator end cap 718 to the end 702 with the connector. The individual then couples the container 714 and the agitator end cap 718 to a drive mechanism that causes the agitator to rotate and mix the food product 712 and the liquid 720. The airtight seal 708 may then be removed and the container, with the agitator end cap secured, may be given to a customer. Alternatively, a straw may be inserted through the area of weakness 710 in the airtight seal 708.

FIGS. 11A, 11B, and 11C show containers 1000, 1100, and 1200 respectively. The containers 1000, 1100, and 1200 may include an integral agitator disposed about a base portion. The container 1000, 1100, and 1200 are configured for holding a liquid. The interior volume of the container 1000, 1100, and 1200 may be 6 oz to 32 oz, preferably 10 oz to 24 oz, more preferably 16 oz to 24 oz. The containers 1000, 1100, and 1200 include a base portion 1004, 1104, 1204, the base portion having a first generally planar region proximate a perimeter of the container, and an upwardly extending region 1006, 1106, 1206 extending from the planar region. As shown in FIG. 11A and 11C, the upwardly extending region may include a generally serpentine surface. The containers 1000, 1100, 1200 may include a sidewall 10008, 1108, 1208 extending upwardly from the base portion about the perimeter. An agitator 1018 and 1218 may be integral formed with the generally serpentine surface. The generally serpentine surface may be configured to allow a distal end 1018A, 1218A of the agitator 1018, 1218 to move relative to the base portion 1004, 1204. The distal end 1018A, 1218A of the agitator 1018, 1218 may be caused to oscillate, rotate, or move about a non-circular path when driven by a driver mechanism (see FIG. 13B). Oscillate means that the end 1018A, 1218A of the agitator 1018, 1218 moves from a first position to a second position along a first path and then returns to the first position along the same path (see FIG. 13B). By rotate it is meant the end 1018A, 1218A of the agitator 1018, 1218 moves about a path defined by a circular path (see FIG. 13B). The serpentine surface may be formed by a plurality of concentric ribs formed about a longitudinal axis of the container.

The upwardly extending region 1006, 1106, 1206 and the base region 1004, 1104, 1204 are preferably formed of a common material and may be formed at the same time. The sidewall 1008, 1108, 1208, the base region 1004, 1104, 1204 the upwardly extending region 1006, 1106, 1206, and the agitator 1018, 1118, 1218 may be formed from a polymeric material including but not limited to polystyrene, polyethylene, polypropylene, polyester, polycarbonate, and ABS, formed by a forming process including, but not limited to injection molding, thermoforming, slush molding, blow molding, and compression molding. The container may also be formed by a blend or alloy of polymeric material. In another embodiment, the container may be of composite construction. The sidewall may be formed from a different material from the upwardly extending region, the agitator, and the base portion. For example, the sidewall may be formed of a paper-based material. The container may further include an airtight seal disposed across an opening of the container. The airtight seal may be used to help preserve a food product stored in the container. The components, upwardly extending portion, base region, sidewall, and agitator, may be formed by a composite forming operation i.e. different operations are used to form the sidewall and the base.

In FIG. 11A and FIG. 14, the agitator 1018 includes a hollow portion. One end 1018A of the agitator 1018 is sealed and an opposing end 1018B is open to the outside of the container. In a preferred alternative embodiment, the agitator is integrally formed with the base portion, i.e., it is of unitary construction and is not separately formed and joined to the base portion.

The hollow portion of the agitator may be configured to allow a shaft to be at least partially inserted therein. The agitator may be moved by an inserted shaft. The outside shape of the agitator 1018 may be any shape including, but not limited to a circle and an oval. The length of the agitator 1018 above the upwardly extending region 1006 may be 5% to 50%, preferably 5% to 30% of the overall height of the container 1000. Alternatively, although not shown in FIG. 14, it is clear that the base can extend completely across the bottom of the container, and the agitator 1018 can extend upwardly from such base.

In FIG. 11C and FIG. 16, an agitator 1218 includes an elongated shaft that extends upwardly and downwardly from the serpentine surface. The portion of the shaft that extends upwardly may be straight or bent. The portion of the shaft that extends downward can be moved by a driver mechanism having a properly configured drive coupling. The outside shape of the shaft 1118 may be any shape including, but not limited to a circle and an oval. The length of the agitator 1118 above the upwardly extending region 1106 may be 5% to 50%, preferably 55 to 30% of the overall height of the container 1100. The portion 1218B, 1418B of the shaft that extends downward preferably does not extend beyond the base portion 1204, 1404. The distance from the bottom of the shaft to the base is shown as “D”, which is preferably greater than or equal to zero. This allows the base portion 1204, 1404 of the container 1200, 1400 to sit on a flat surface without tipping to one side.

In one embodiment, the upwardly extending region 1006, 1206 or the agitator 1018, 1218 may be first formed and then insert molded with the base region 1004, 1204 and/or the upwardly extending region 1003, 1206.

FIG. 13 shows details of a drive mechanism 1300 for use with the container 1000, 1200 of FIG. 11A and 11B. The drive mechanism includes a housing 1302, a motor 1304 substantially enclosed within the housing, the motor having a longitudinally rotatable output shaft, a power source for movement of the output shaft, and a linkage 1306 (see FIG. 13A) coupled to the output shaft, the linkage 1306 configured to cause an end of the linkage to oscillate through an angle θ. The angle θ may be from 5° to 50°. Other linkage may be used to achieve an oscillating output. An end 1306′, of the linkage 1306, may be at least partially inserted in the end 1018E of agitator 1018 disposed in the base portion of the container 1000. Alternatively, the linkage 1306′ may include a coupling for coupling the linkage to the lower portion of agitator 1218 of container 1200. The housing 1302 may be configured to receive the containers 1000 and 1200. In an alternatively drive mechanism, the linkage may cause an end of the linkage to move in a non-circular path. In another alternative embodiment, the drive mechanism may cause an agitator to rotate.

The housing 1302 may further include a manual actuator 1308 electrically coupled to the motor 1304 allowing a user to turn the motor on and off. Alternatively, the housing may include an actuator 1310 coupled to the motor 1304, actuation of the actuator 1310 by a mixing container causing the motor 1304 to rotate. Alternatively, a sensor may be included in the housing that is configured to sense coupling of a mixing container to the drive mechanism. The sensor generating a signal when a mixing container is coupled to the drive mechanism, thereby causing the motor to rotate.

In FIG. 11B and FIG. 15, a container 1100 is shown. The container includes a base portion 1104, an upstanding portion 1106, an agitator 1118 mechanically coupled to the upstanding portion 1106, and a sidewall 1108 extending upwardly from the base portion 1104. A prepackaged food product may include the container 1100 and a food product 1140 disposed in an interior volume formed by the base portion 1104, the sidewall 1108, and an airtight seal 1142 contacting the sidewall for preserving the food product. The interior volume of the container 1000, 1100, and 1200 may be 6 oz to 32 oz, preferably 10 oz to 24 oz, more preferably 16 oz to 24 oz. The agitator 1118 may be rotatable about the base portion 1104. The agitator 1118 may include a first surface 1150 disposed within the interior volume; the first surface 1150 comprises an upwardly extending fin 1152 or a plurality of upwardly extending fins. The agitator 1118 may further include a drive coupling 1156 that extends downwardly from the upstanding portion towards the base 1104, but does not extend beyond the base portion 1104. The coupling coupleable to an output shaft of a drive motor. The fins 1152 rotating in a circular path when the drive coupling is rotated. The distance from the bottom of the drive coupling 1156 to the base 1104 is shown as “D”, which is preferably greater than or equal to zero. This allows the base portion 1104 of the container 1100 to sit on a flat surface without tipping to one side. FIG. 12 shows a container 1000, 1100 or 1200 coupled to a drive mechanism.

FIG. 15 is a section view of the container 1100 of FIG. 11B. The agitator 1118 may be formed in a separate forming step from the base portion 1104, the upstanding region 1106, and the sidewall 1108. The agitator 1118 may be inserted through an opening formed in the upwardly extending region 1106. The agitator 1118 may be moveable between a first position in which the agitator can be freely rotated and a second position in which the agitator is sealed to the upwardly extending portion to prevent leakage of liquid from the container 1100. The upwardly extending portion and the agitator may have cooperating protrusions 1160 and indentations 1162 to provide a seal 1158. The seal 1158 may be located between surfaces of the agitator and the upwardly extending portion or horizontal surface 1106. To mix the ingredients inside the container 1100, the agitator may be pulled downward into the first position and to seal the liquid in the container when the mixing is complete, the agitator may be moved upward to the second position. In an alternative embodiment, a seal may be added on the outside of the container after mixing to prevent leaks. In another embodiment, agitator may be sealed to the upwardly extending portion through the use of heat or force.

FIG. 17 shows an alternative container construction. A container 1400 has an upwardly extending portion 1406 that is coupled to a base portion 1404 located along a bottom edge of sidewall 1408. The upwardly extending portion 1406 and the base portion may be joined so as to prevent the egress of liquids. As noted above, the upwardly extending portion 1406 may be made separately from the other components of a similar or dissimilar material from a similar or dissimilar forming process. An agitator 1418 may be integrally formed with the upwardly extending portion 1406. Other agitators, for example the agitator shown in FIGS. 11A and 14, may be substituted for the agitator 1418 and should be considered part of the applicant's invention.

A feature or features shown in one embodiment may be combined with another embodiments and shall be considered part of the applicant's invention.

It should be understood that, while the present invention has been described in detail herein, the invention can be embodied otherwise without departing from the principles thereof, and such other embodiments are meant to come within the scope of the present invention as defined in the following claim(s):

We claim:

1. A prepackaged food product, comprising;
a container having a connector at an open end for securing the container to a mixing apparatus;
an airtight seal covering the open end;
a food product enclosed between the container and the seal;
a cover securable to the open end, the cover comprising an agitator for causing mixing of the food product.

2. The prepackaged food product of claim 1, wherein the connector comprises a screw thread.

3. The prepackaged food product of claim 1, wherein the connector comprises a means for securing the container to the mixing apparatus.

4. The prepackaged food product of claim 1, wherein the food product comprises fruit.

5. The prepackaged food product of claim 1, wherein the cover further comprises a drive mechanism for driving the agitator.

6. The prepackaged food product of claim 1, wherein the container comprises indicia indicative of a predetermined quantity of an ingredient to be added to the container.

7. The prepackaged food product of claim 1, wherein the container comprises indicia indicative of a predetermined volume of a liquid to be added to the container.

8. The prepackaged food product of claim 7, wherein the liquid to be added comprises water.

9. The prepackaged food product of claim 7, wherein the liquid to be added comprises a dairy product.

10. A prepackaged food product comprising;
a container;
a divider for dividing the container into a plurality of smaller compartments, the divider contained within an interior volume of the container, wherein a first compartment comprises a first food product and a second compartment comprises a second food product.

11. The prepackaged food product of claim 10, wherein the divider comprises a plastic.

12. The prepackaged food product of claim 10 wherein the divider comprises a liquid soluble material.

13. The prepackaged food product of claim 10 wherein the divider is edible.

14. The prepackaged food product of claim 10 further comprising an airtight seal covering an end of the container.

15. The prepackaged food product of claim 10 wherein the divider divides the container into a plurality of smaller vertical compartments.

16. The prepackaged food product of claim 10 wherein the divider divides the container into a plurality of smaller horizontal compartments.

17. The prepackaged food product of claim 10 wherein the container comprises a centrally located protrusion extending upwardly from a base of the container.

18. The prepackaged food product of claim 17 wherein the divider comprises a plurality of fins extending radially outward from the centrally located protrusion.

19. A prepackaged food product, comprising;
a container having an interior volume and an open end,
a food product;
an agitator spaced from the open end for causing mixing of the food product, and
an airtight seal covering the open end.

20. The prepackaged food product of claim 19, wherein the container comprises a drive mechanism for driving the agitator.

21. The prepackaged food product of claim 19, wherein at least a portion of the food product comprises fruit.

22. The prepackaged food product of claim 19, wherein the seal comprises an area of mechanical weakness.

23. The prepackaged food product of claim 19, wherein the seal comprises a removable cap.

24. The prepackaged food product of claim 23, wherein the removable cap is resealable.

25. The prepackaged food product of claim 19, wherein a pressure in the interior of the container is different from the pressure outside the container.

26. The prepackaged food product of claim 19, wherein the container comprises a polymeric material.

27. The prepackaged food product of claim 25, wherein the pressure in the interior of the container is less than the pressure outside the container.

28. The prepackaged food product of claim 19, wherein the interior of the container is free of oxygen.

29. A drive mechanism, comprising:
a housing, the housing configured to engageably couple a pair of parallel generally planar surfaces,
a motor substantially enclosed within the housing, the motor having an output shaft, the motor coupleable to a power source for causing actuation of the output shaft.

30. The drive mechanism of claim 29, further comprising a coupling coupled to the output shaft.

31. The drive mechanism of claim 30, wherein the coupling is configured to drive an agitator disposed in a base of a mixing container.

32. The drive mechanism of claim 31, wherein the housing further comprises an actuator coupled to the motor, actuation of the actuator by the mixing container causing the motor to operate.

33. The drive mechanism of claim 29, wherein the output shaft rotates about a longitudinal axis of the output shaft.

34. The drive mechanism of claim 29, wherein an end of the output shaft oscillates.

35. The drive mechanism of claim 29, wherein the housing is configured to receive a container.

36. A prepackaged food product, comprising;
a container having a first end and a second end, the container comprising a connector at the first end for securing the container to a mixing apparatus;
a first airtight seal covering the first end;
a second airtight seal covering the second end; and
a food product dispose within the container.

37. The prepackaged food product of claim 36, wherein the connector comprises a screw thread.

38. The prepackaged food product of claim 36, wherein at least a portion of the food product comprises fruit.

39. The prepackaged food product of claim 36, further comprising an agitator for causing mixing of the food product, the agitator coupleable to the connector.

40. The prepackaged food product of claim 39, wherein the agitator further comprises a drive mechanism for driving the agitator.

41. The prepackaged food product of claim 36, wherein the container comprises indicia indicative of a predetermined quantity of an ingredient to be added to the container.

42. The prepackaged food product of claim 36, wherein the container comprises indicia indicative of a predetermined volume of a liquid to be added to the container.

43. The prepackaged food product of claim 42, wherein the liquid to be added comprises water.

44. The prepackaged food product of claim 42, wherein the liquid to be added comprises a dairy product.

45. A container for holding a food product, comprising:
a base portion, the base portion having a first generally planar region proximate a perimeter,
an upwardly standing region located within the base portion;
an agitator integral with the upwardly standing region; and
a side wall extending upwardly from the base portion about the perimeter.

46. The container for holding a food product of claim 45, wherein the upwardly standing region comprises an area of mechanical weakness.

47. The container for holding a food product of claim 45, wherein the upwardly standing region comprises a plurality of concentric ribs.

48. The container for holding a food product of claim 45, wherein the agitator comprises a different material than the base portion.

49. The container for holding a food product of claim 45, wherein the agitator and the base portion comprises a common material.

50. The container for holding a food product of claim 45, wherein the agitator is insert molded in the base portion.

51. The container for holding a food product of claim 45, wherein the base portion, the upwardly standing portion and the agitator comprises a common material.

52. The container for holding a food product of claim 45, wherein the agitator is configured to oscillate about a centerline of the agitator.

53. The container for holding a food product of claim 45, wherein the agitator comprises a hollow portion, the hollow portion having an open end facing the base portion to allow a drive element to be inserted therein.

54. The container for holding a food product of claim 45, wherein the drive element is a shaft.

55. The container for holding a food product of claim 45, wherein the agitator extends upwardly and downwardly from the upwardly standing portion.

56. The container for holding a food product of claim 55, wherein the agitator is configured to oscillate.

57. The container for holding a food product of claim 45, further comprising an airtight seal disposed across an opening of the container.

58. A prepackaged food product, comprising:
a base portion;
an upwardly standing region located within the base portion
an agitator mechanically coupled to the upwardly standing region;
a side wall extending upwardly from the base portion, the upwardly standing region and the sidewall forming an interior volume,
a food product disposed in the interior volume; and
an air tight seal contacting the sidewall for preserving the food product.

59. The prepackaged food product of claim 58, wherein the agitator is rotatable relative to the base portion.

60. The prepackaged food product of claim 58, wherein the agitator comprises a first surface disposed within the interior volume, the first surface comprising a fin.

61. The prepackaged food product of claim 60, wherein the first surface comprises a plurality of fins.

62. The prepackaged food product of claim 58, wherein the agitator comprises a downwardly extending protrusion coupleable to a drive mechanism for causing rotation of the agitator.

63. The prepackaged food product of claim 58, wherein the agitator comprises a second surface disposed outside the interior volume, the second surface comprising a protrusion extending downwardly from the base portion and configured for coupling to an output shaft of a drive motor.

64. A blender base, comprising:
a housing;
a motor substantially enclosed within the housing, the motor having a longitudinally rotatable output shaft;
a linkage coupled to the output shaft and a coupled member, the linkage configured to cause an end of the coupled member to move about a non circular path; and
a power source for causing rotation of the output shaft.

65. The blender base of claim 64, wherein the coupled member is configured to drive an agitator disposed in a base of a mixing container.

66. The blender base of claim 65, wherein the housing further comprises an actuator coupled to the motor, actuation of the actuator by the mixing container causing the motor to rotate.

67. The blender base of claim 64, wherein the housing is configured to receive a container.

68. A blender base, comprising:
a housing;
a motor substantially enclosed within the housing, the motor having an output shaft;
a linkage coupled to the output shaft configured to cause a coupled member to oscillate; and
a power source for causing rotation of the output shaft.

69. The blender base of claim 68, wherein the coupled member is configured to drive an agitator disposed in a base of a mixing container.

70. The blender base of claim 68, wherein the housing further comprises an actuator coupled to the motor, actuation of the actuator by the mixing container causing the motor to rotate.

71. The blender base of claim 68, wherein the housing is configured to receive a container.

72. A prepackaged food product, comprising:
a base portion;
an upwardly standing region located within the base portion;
a side wall extending upwardly from the base portion, the upwardly standing region and the sidewall forming an interior volume,
an agitator integrally formed with the upwardly standing region and extending into the interior volume;
a food product disposed in the interior volume; and
an air tight seal contacting the sidewall for preserving the food product.

73. A container for mixing ingredients, comprising:
a container having a base portion, an upwardly standing region located within the base portion, and a side wall extending upwardly from the base portion; and
an agitator, the agitator comprising a first portion that extends from the upwardly standing region away from the base and a second drive portion, the drive portion not extending beyond the base portion.

74. The container for mixing ingredients of claim 73, wherein the agitator rotates relative to the upwardly extending region.

75. The container for mixing ingredients of claim 73, wherein the agitator oscillates relative to the upwardly extending region.

76. A system for mixing ingredients, comprising
a container having a base portion, an upwardly standing region located within the base portion, and a side wall extending upwardly from the base portion; and
an agitator, the agitator insertable through an opening formed in the upwardly standing region, the agitator moveable between a first position in which the agitator can be rotated and a second position in which the agitator is fluidly sealed to the upwardly standing region to prevent leakage of liquid from the container.

77. The system of claim 76, wherein the upwardly extending region and the agitator have cooperating protrusions and indentations to provide the seal.

78. A container for holding a food product, comprising:
a base portion;
a side wall extending upwardly from the base portion;
an upwardly standing region coupled to the side wall and the base portion, the side wall, and the upwardly standing region defining an interior volume; and
an agitator integrally formed with the upwardly standing region and extending into the interior volume.

79. The container for holding a food product of claim 78, wherein the agitator comprises a hollow portion, the hollow portion having an open end facing the base portion to allow a drive element to be inserted therein.

80. The container for holding a food product of claim 78, wherein a first portion of the agitator extends upwardly from the upwardly standing portion and a second portion extends downwardly from the upwardly standing portion, but the second portion does not extend beyond the base portion.

81. A container of two-part construction, said two parts forming a container and an agitator sealed to prevent the egress of a food product, comprising:
a container having a base portion, an upwardly standing region located within the base portion, and a side wall extending upwardly from the base portion; and
an agitator rotatable about the upwardly standing region.

82. A container for holding a food product, comprising:
a base portion, the base portion having a first generally planar region;
a side wall extending upwardly from the base portion, the side wall and the base defining an interior volume; and
an agitator integral in the base portion and extending into the interior volume.

83. The container for holding a food product of claim 82 wherein said base portion includes a serpentine surface structure.
